(19) United States
(12) Patent Application Publication
(10) Pub. No.: US 2025/0162462 A1
(43) Pub. Date: May 22, 2025

(54) SYSTEMS AND METHODS FOR OPERATING ELECTRIC VEHICLES IN COLD CLIMATES

(71) Applicant: TUGLIQ ENERGY CO., Montréal (CA)

(72) Inventors: Paul-Étienne CARRIER, Montréal (CA); Olivier CÔTÉ, Saint-Colomban (CA)

(73) Assignee: TUGLIQ ENERGY CO., Montréal, QC (CA)

(21) Appl. No.: 18/841,179

(22) PCT Filed: Feb. 23, 2023
(86) PCT No.: PCT/CA2023/050225

§ 371 Date: Aug. 23, 2024

Related U.S. Application Data
(60) Provisional application No. 63/314,234, filed on Feb. 25, 2022.

(51) Int. Cl. B60L 58/27; B60L 58/12

(52) U.S. Cl. CPC B60L 58/27; B60L 58/12; B60L 2240/545; B60L 2270/44

(57) ABSTRACT

There is described systems and methods for managing the temperature of a battery in an electric vehicle. The system comprises a fuel-operated heater configured to heat a heat transfer fluid and an electric heater configured to heat the heat transfer fluid. The system also comprises control system configured to selectively operate the fuel-operated heater or the electric heater. The system also comprises a thermally insulated battery enclosure configured to receive heated heat transfer fluid to heat the battery. The control system may be configured to automatically select operation of the electric heater or the fuel-operated heater based at least in part on the state of charge of the battery of the electric vehicle, the location of the electric vehicle, the temperature outside the electric vehicle and/or the temperature of the battery of the electric vehicle.

### CROSS-REFERENCE TO PREVIOUS APPLICATION

This application claims priority from U.S. provisional patent application No. 63/314,234 filed on Feb. 25, 2022, which is incorporated herein by reference in its entirety.

### FIELD

The present disclosure relates to the use of electric vehicles in cold climates. In particular, the present disclosure relates to systems and methods for managing the battery and/or cabin temperatures of electric vehicles in cold climates.

### INTRODUCTION

As the use of electric vehicles increases in industrial settings, a larger number of electric vehicles are used in cold and remote locations. Most cold and remote locations, such as islands, remote communities and mining operations in the Arctic or Antarctic, currently rely on fossil fuels for energy generation, transportation, and heat. Use of electric vehicles in such locations can significantly reduce Greenhouse Gas (GHG) emissions associated with transportation in such locations by replacing fossil fuels with local energy sources such as autonomous hybrid networks.

One significant disadvantage with the use of electric vehicles in such cold and remote locations are the intrinsic and extrinsic decreases in battery capacity in cold weather. In particular, the intrinsic chemical reduction-oxidation reaction in a battery is slowed as the temperature of the battery is reduced, which in turn leads to a weakening of the output power of the battery. This disadvantage is typically mitigated by using a portion of the electricity produced to heat the battery. While this technique can increase the output power of the battery, it does so at the cost of decreasing battery capacity.

Moreover, cold climates often require heating the interior of an electric vehicle (also known as the “cabin” of the vehicle) for the survival and/or wellbeing of vehicle drivers and passengers, which results in a further extrinsic load on the battery of the electric vehicle. This problem can be compounded by operation of the electric vehicle in remote locations, such as arctic mines, in which vehicle operators and other workers may not have access to a heated shelter, other than the interior of an electric vehicle. This can result in the need to maintain the interior of the vehicle warm of longer periods of time, thereby further reducing the capacity of the battery.

The aforementioned decreases in capacity can result in a significant drain on the battery of an electric vehicle operating in cold and remote locations. For example, it is estimated that even at a relatively mild outdoor temperature of −7 C°, heating the interior of an electric vehicle and keeping the battery of an electric vehicle warm can reduce the capacity of the battery by 41%. As will be appreciated by the skilled reader, this reduction will be increased by a decrease in outdoor temperature.

There is therefore a clear need for improved systems and methods for managing the battery and/or cabin temperatures of electric vehicles in cold climates.

### SUMMARY

The following summary is intended to introduce the reader to the more detailed description that follows, and not to define or limit the claimed subject matter.

The present disclosure generally relates to systems and methods for managing the battery and/or cabin temperatures of electric vehicles in cold climates by providing supplementary fuel-based heating sources. The present disclosure also generally relates to systems and methods of managing the use of electric heating sources and fuel-based heating sources.

The claimed subject matter provides the advantages of allowing users of the systems and methods described herein to either select a heating energy source by way of a manual mode (either all-electric or all-fuel) or let the automatic mode select the heating energy source or a certain predefined combination of heating energy sources depending on vehicle and environmental conditions. Moreover, the systems and methods of the present invention are suitable for converting fuel-based vehicles into electric vehicles suitable for use in extreme conditions, such as the arctic.

According to one aspect of the present disclosure, there is provided a system for managing the temperature of a battery in an electric vehicle. The system comprises a fuel-operated heater configured to heat a heat transfer fluid and an electric heater configured to heat the heat transfer fluid. The system also comprises a control system configured to selectively operate the fuel-operated heater or the electric heater. The system also comprises a thermally insulated battery enclosure configured to receive heated heat transfer fluid to heat the battery.

In some examples, the fuel-operated heater is a diesel heater.

In some examples, the fuel-operated heater is one of a parking heater, a diesel-fired air heater, a diesel-fired coolant heater, a petrol-fired air heater and a petrol-fired coolant heater.

In some examples, the system further comprises a heat exchanger configured to heat a cabin of the electric vehicle using the heat transfer fluid.

In some examples, the system further comprises a second fuel-operated heater configured to heat the heat transfer fluid used by the heat exchanger.

In some examples, the system further comprises a second electric heater configured to heat the heat transfer fluid used by the heat exchanger.

In some examples, the control system is operable by an operator of the electric vehicle.

In some examples, the control system is configured to automatically select operation of the electric heater or the fuel-operated heater based at least in part on the state of charge of the battery of the electric vehicle.

In some examples, the control system is configured to automatically select operation of the electric heater or the fuel-operated heater based at least in part on the location of the electric vehicle.

In some examples, the control system is configured to automatically select operation of the electric heater or the fuel-operated heater based at least in part on the temperature outside the electric vehicle.

In some examples, the control system is configured to automatically select operation of the electric heater or the fuel-operated heater based at least in part on the temperature of the battery of the electric vehicle.

According to another aspect of the present disclosure, there is provided a method of operating the aforementioned system. The method comprises determining the state of charge (SoC) of the battery of the electric vehicle. The method also comprises selecting the fuel-operated heater if the state of charge (SoC) is below a threshold.

According to yet another aspect of the present disclosure, there is provided a method of operating the aforementioned system. The method comprises determining the state of charge (SoC) of the battery of the electric vehicle and determining the temperature outside the electric vehicle. The method also comprises selecting the fuel-operated heater if the state of charge (SoC) is below a state of charge threshold and the temperature outside the electric vehicle is below an outside temperature threshold.

According to yet another aspect of the present disclosure, there is provided a method of operating the aforementioned system. The method comprises the steps of determining the geographic location of the electric vehicle and determining a state of charge threshold based at least in part on the geographic location of the electric vehicle. The method also comprises determining the state of charge (SoC) of the battery of the electric vehicle and determining the temperature outside the electric vehicle. The method also comprises selecting the fuel-operated heater if the state of charge (SoC) is below the determined state of charge threshold and the temperature outside the electric vehicle is below an outside temperature threshold.

In some examples, the aforementioned methods can further comprise receiving instructions from the operator of the electric vehicle and selectively operating the fuel-operated heater or the electric heater based on a request contained in the instructions.

According to yet another aspect of the present disclosure, there is provided a method of charging an electric vehicle comprising the aforementioned system. The method comprises determining the state of charge (SoC) of the battery of the electric vehicle; and determining the temperature of the battery of the electric vehicle. The method also comprises prioritizing the use of the received charging energy to heat the heat transfer fluid using the electric heater if the state of charge (SoC) is above a state of charge threshold and the temperature of the battery of the electric vehicle is below a battery temperature threshold. The method also comprises prioritizing the use of the received charging energy to increase state of charge (SoC) of the battery of the electric vehicle if the state of charge (SoC) is not above a state of charge threshold or the temperature of the battery of the electric vehicle is not below a battery temperature threshold.

In some examples, prioritizing the use of the received charging energy to heat the heat transfer fluid using the electric heater comprises using 98% of the energy received from the outside energy source to maintain the temperature of the battery above the battery temperature threshold and using 2% of the energy received from the outside energy source to conserve the SoC of the battery.

In some examples, prioritizing the use of the received charging energy to increase the state of charge (SoC) of the battery of the electric vehicle comprises using 100% of the energy received from the outside energy source to increase the state of charge of the battery of the electric vehicle

### DRAWINGS

In order that the claimed subject matter may be more fully understood, reference will be made to the accompanying drawings, in which:

FIG. 1 is a schematic diagram showing the exemplary locations of the cabin and insulted battery enclosure of an electric vehicle suitable for use in a cold and remote location in accordance with an embodiment of the present disclosure;

FIG. 2 is a schematic diagram showing a battery temperature management system in accordance with an embodiment of the present disclosure;

FIG. 3 is a schematic diagram showing a cabin temperature management system in accordance with an embodiment of the present disclosure;

FIG. 4 is a schematic diagram showing a battery and cabin temperature management system in accordance with another embodiment of the present disclosure;

FIG. 5 is a schematic diagram showing a control system for the temperature management systems of FIG. 1, FIG. 2 and/or FIG. 3;

FIG. 6 is a block diagram of an example temperature management method carried out by the system of FIG. 5;

FIG. 7 is a block diagram of another example temperature management method carried out by the system of FIG. 5;

FIG. 8 is a block diagram of yet another example temperature management method carried out by the system of FIG. 5;

FIG. 9 is a block diagram of yet another example temperature management method carried out by the system of FIG. 5;

FIG. 10 is a block diagram of yet another example temperature management method carried out by the system of FIG. 5;

FIG. 11 is a block diagram of yet another example temperature management method carried out by the system of FIG. 5; and

FIG. 12 is a block diagram of a charging method carried out by the system of FIG. 5.

### DESCRIPTION OF VARIOUS EMBODIMENTS

It will be appreciated that, for simplicity and clarity of illustration, where considered appropriate, reference numerals may be repeated among the figures to indicate corresponding or analogous elements or steps. Numerous specific details are set forth in order to provide a thorough understanding of the exemplary embodiments of the subject matter described herein.

However, it will be understood by those of ordinary skill in the art that the embodiments described herein may be practiced without these specific details. In other instances, well-known methods, procedures, and components have not been described in detail so as not to obscure the present subject matter. Furthermore, this description is not to be considered as limiting the scope of the subject matter in any way but rather as illustrating the various embodiments.

As used herein, “battery temperature” and “cell temperature” mean the average battery cell temperature in a multi-cell battery pack.

As used herein, “electric vehicle” refers to any vehicle that uses one or more electric motors for propulsion.

As used herein, “state of charge” (SoC) refers to the level of charge of an electric battery relative to its capacity and is expressed in percentage points (0%=empty; 100%=full). Alternatively, or additionally, the Depth of Discharge (DoD), which is generally the inverse of the SoC can also be used by the methods and systems described herein, as will be appreciated by a skilled reader.

As used herein, “cabin” means any interior space in an electric vehicle that can be occupied by a driver or passenger including, but not limited to, a car interior, a truck interior, a sleeper cab, and any other interior living, sleeping or travelling space forming part of a vehicle.

As used herein, “fuel-operated heater” means any device suitable for converting fuel into heat though a combustion chemical reaction including, but not limited to, parking heaters, diesel-fired air heaters, diesel-fired coolant heaters, petrol-fired air heaters and petrol-fired coolant heaters, such as those manufactured by the Eberspächer Group™ or those manufactured by the Webasto Group™.

As used herein, “heat transfer fluid” or “coolant” means a substance, including liquids or gases, that is suitable to reduce or increase the temperature of a system. A heat transfer fluid can have a high thermal capacity and low viscosity. A non-limiting example of a heat transfer fluid is a mixture of water and ethylene glycol, which is commonly used in the automotive industry.

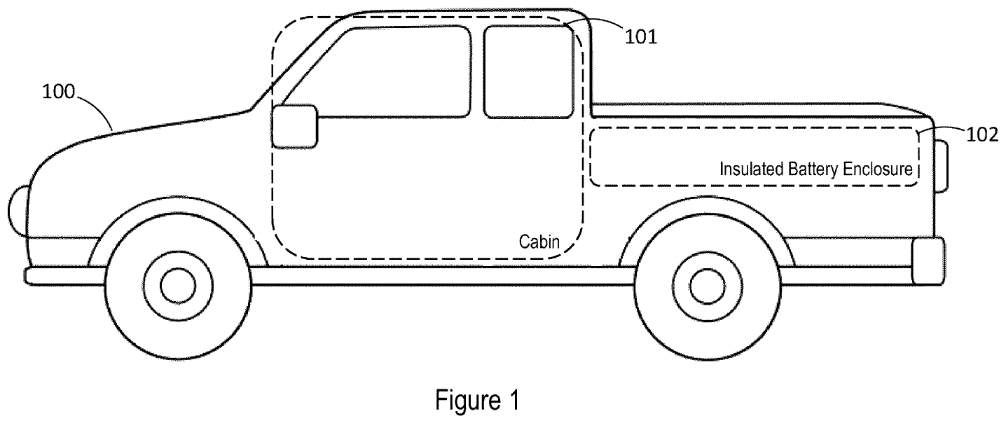

FIG. 1 is a schematic diagram showing the exemplary locations of a cabin 101 and insulted battery enclosure 102 in an electric vehicle 100 suitable for use in a cold and remote location in accordance with an embodiment of the present disclosure. As will be appreciate by the skilled reader, while a pickup truck is shown in FIG. 1, the systems and methods of the present disclosure can be used with any other electric vehicle, including, but not limited to, buses, cars, trains, trams, sport utility vehicles (SUVs), recreational vehicles (RVs) and powersport vehicles.

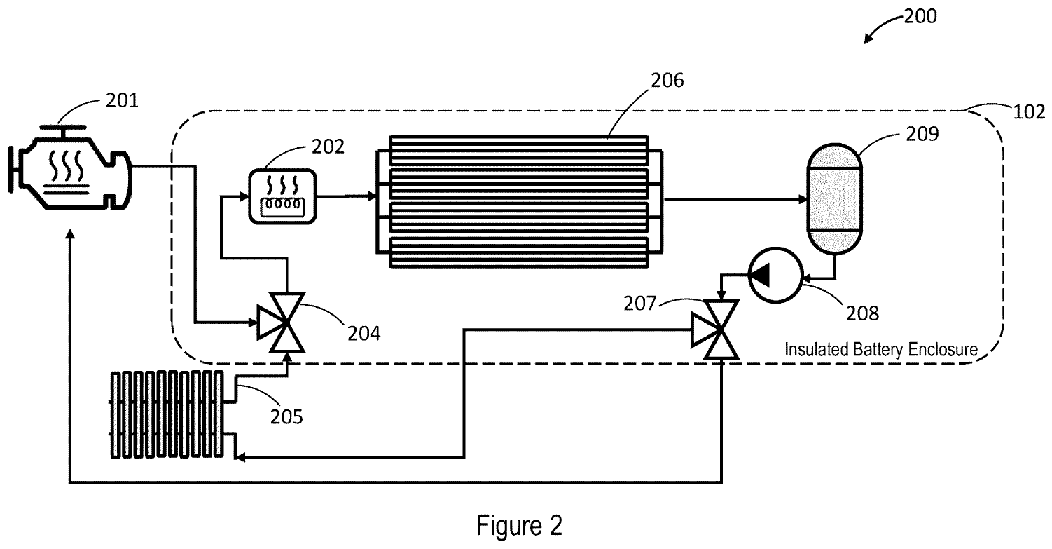

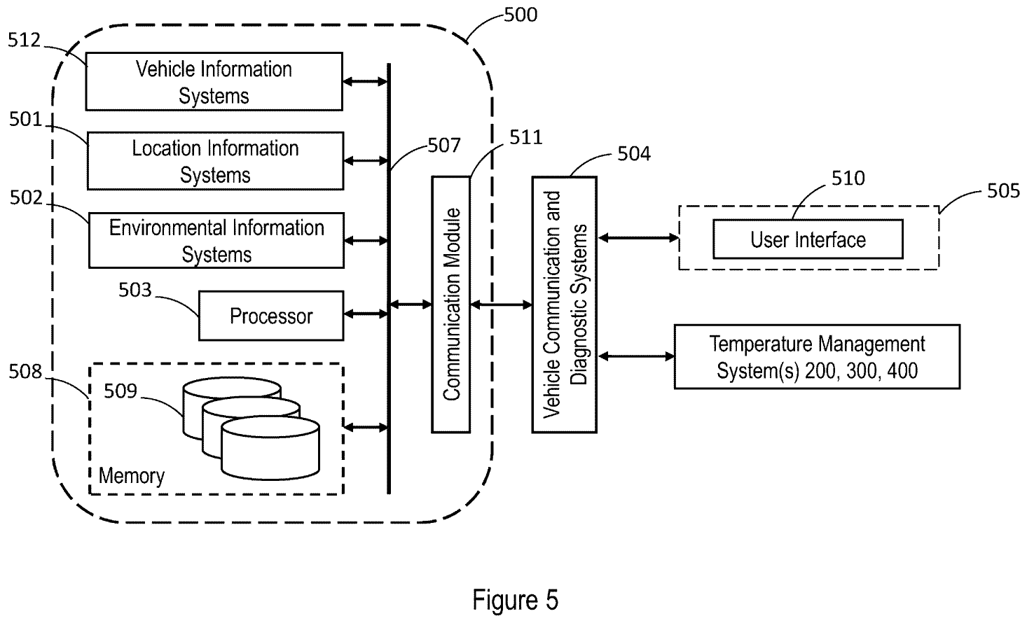

FIG. 2 is a schematic diagram showing a battery temperature management system 200 in accordance with embodiments of the present disclosure. The battery temperature management system comprises a fuel-operated heater 201. In some embodiments, the fuel-operated heater 201 is an air heater. In the embodiment shown in FIG. 2, the fuel-operated heater 201 is a liquid coolant heater. The fuel-operated heater 201 is controlled by the system of FIG. 5, as described in more details elsewhere herein. The output of the fuel-operated heater 201 is in fluid communication with a three-way electronic valve 204 having a first input, a second input and a single output. Three-way electronic valve 204 is controlled by the system of FIG. 5, as described in more detail elsewhere herein. The single output of three-way electric valve 204 is in fluid communication with an electric heater 202 that is powered by the battery of the electric vehicle 100 and controlled by the system of FIG. 5, as described in more detail elsewhere herein. The electric heater 202 is operable to heat the heat transfer fluid received from the three-way electric valve 204.

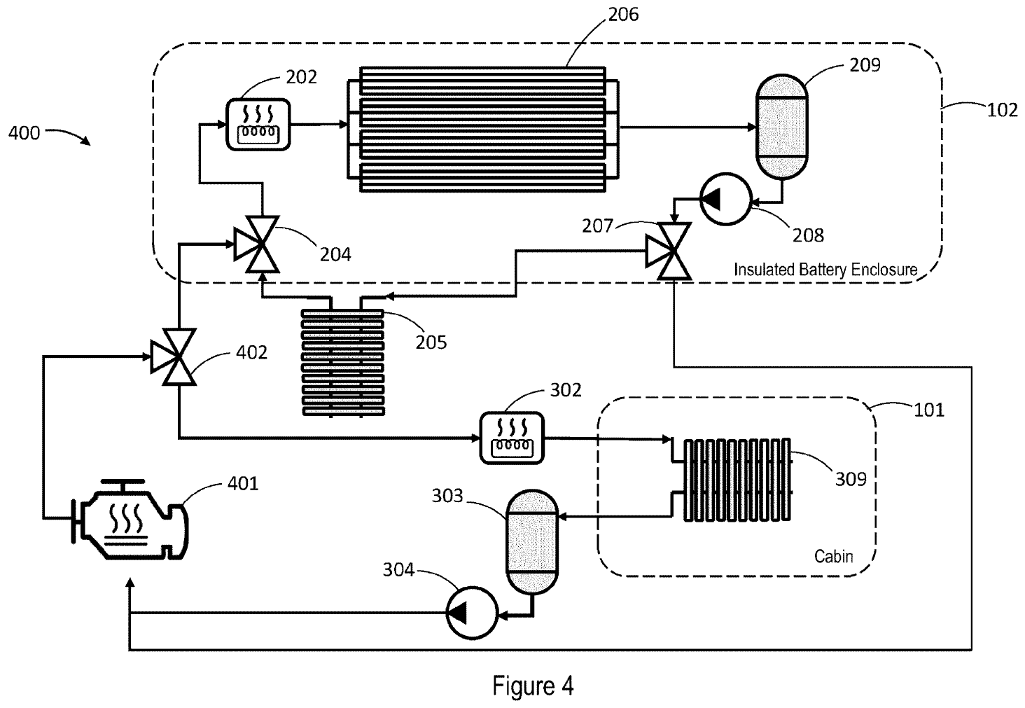

The output of the electric heater 202 is in fluid communication with an insulated battery pack containing the battery (not shown) of the electric vehicle 100. In some embodiments, the battery pack comprises a battery cooling circuit 206 comprising a plurality of tubes located inside the insulated battery pack and surrounding the battery. Battery cooling circuit 206 is configured to receive the heat transfer fluid output from electric heater 202 and to heat the battery if the heat transfer fluid is warmer than the battery. In some embodiments, the battery pack is housed within an insulated battery enclosure 102, along with other components, as shown in FIGS. 2 and 4. In some embodiments, the insulated battery enclosure 102 may comprise a rigid metal enclosure suitable for receiving a battery pack and insulating material. In some embodiments, the insulted battery enclosure 102 is comprised of insulated foam panels “sandwiched” between sheet metal panels. In some embodiments, the battery pack comprises a repurposed known electric vehicle battery pack, such as those manufactured by Tesla®, Inc.

As shown in FIG. 2, when output from battery cooling circuit 206, the heat transfer fluid is collected in a surge tank 209, which is configured to mitigate the effects of changes in the total heat transfer fluid volume contained in the system, which changes can be caused, for example, thermal expansion and contraction. The surge tank 209 may also act as a fluid reservoir for the battery cooling system 200. The surge tank 209 may also allow access to the battery cooling system 200 in order to add and/or remove heat transfer fluid to/from the battery cooling system 200.

The output of surge tank 209 is in fluid communication with a heat transfer fluid pump 208 configured to circulate the heat transfer fluid around system 200. Heat transfer fluid pump 208 may be any electric fluid pump well known in the art.

The output of heat transfer fluid pump 208 is input into a three-way electric valve 207 having a single input and two outputs. Three-way electronic valve 207 is controlled by the system of FIG. 5, as described in more detail elsewhere herein. The first output of three-way electric valve 207 is in fluid communication with an overheating radiator 205, which is configured to remove any excess heat from the heat transfer fluid. Overheating radiator 205 may be located at the front of the vehicle and may be any overheating radiator well known in the art. The second output of three-way electric valve 207 is in fluid communication with the input of fuel-operated heater 201.

The output of overheating radiator 205 is in fluid communication with the second input of three-way electronic valve 204. Three-way electronic valve 204 may be operable to divert fluid from a single input to one of two outputs under electronic control.

Electric heater 202, three-way electronic valves 204, 207, battery cooling circuit 206, surge tank 209 and heat transfer fluid pump 208 are all situated inside insulated battery enclosure 102 and behind a battery case firewall. The aforementioned components are located within insulated battery enclosure 102 because they contain much of the cooling fluid (including the fluid in the fluid lines within the enclosure between these components). As such, keeping these components insulated allows the system to maximize the thermal inertia of the whole insulated battery enclosure 102. In operation, under control of control system 500 set out and described in more detail with reference to FIG. 5 elsewhere herein, the heat transfer fluid in battery temperature management system 200 can be heated on demand by normal operation of fuel-operated heater 201 and/or by normal operation of electric heater 202. As will appreciated, heating the heat transfer fluid with electric heater 202 will require power from the battery. As will also be appreciated, heating the heat transfer fluid with fuel-operated heater 201 will require fuel, such as, for example, gasoline or diesel.

Once heated, the heat transfer fluid can flow through battery cooling circuit 206 to heat the battery. Heat transfer fluid existing the battery cooling circuit 206 then flows back into the fuel-operated heater 201 or overheating radiator 205 via surge tank 209, heat transfer fluid pump 208 and three-way electronic valves 207. Typically, heat transfer fluid will only flow into overheating radiator 205 if an excess of heat is required to be removed from battery temperature management system 200.

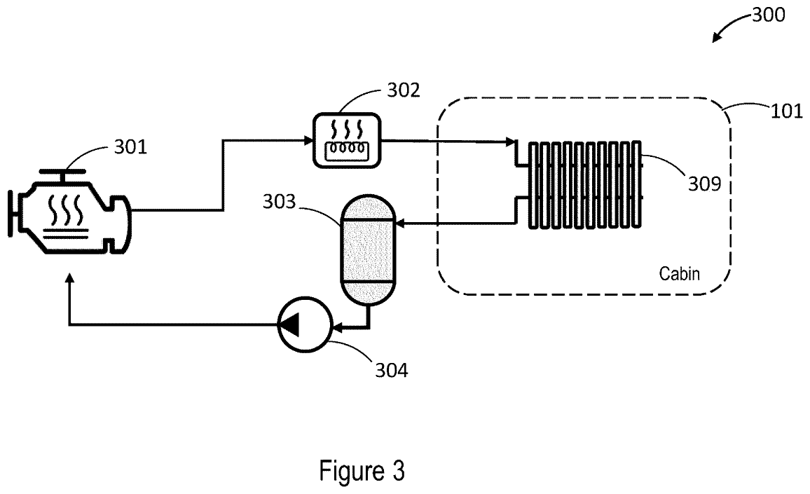

FIG. 3 is a schematic diagram showing cabin temperature management system 300 in accordance with an embodiment of the present disclosure. The cabin temperature management system comprises a fuel-operated heater 301. In some embodiments, the fuel-operated heater 301 is an air heater. In the embodiment shown in

FIG. 3, the fuel-operated heater 301 is a liquid coolant heater. The output of the fuel-operated heater 301 is in fluid communication with an electric heater 302 that is powered by the battery of the electric vehicle 100 and controlled by the system of FIG. 5, as described in more detail elsewhere herein. The electric heater 302 is operable to heat the heat transfer fluid received from the fuel-operated heater 301. The fuel-operated heater 301 is controlled by the system of FIG. 5, as described in more details elsewhere herein. The output of the electric heater 302 is in fluid communication with a heat exchanger 309 located inside the cabin 101 of vehicle 100. In some embodiments, the heat exchanger 309 comprises a heater core provided by the Original Equipment Manufacturer (OEM) of the vehicle.

As shown in FIG. 3, when output from heat exchanger 309, the heat transfer fluid is collected in a surge tank 303, which is configured to mitigate the effects of changes in the total heat transfer fluid volume contained in the system, which changes can be caused, for example, by thermal expansion and contraction. The output of surge tank 303 is in fluid communication with a heat transfer fluid pump 304 configured to circulate the heat transfer fluid around system 300. The output of heat transfer fluid pump 304 is in fluid communication with the input of fuel-operated heater 301.

FIG. 4 is a schematic diagram showing a combined battery and cabin temperature management system 400 in accordance with another embodiment of the present disclosure. The system shown in FIG. 4 is a combination of the system 200 described with reference to FIG. 2 and the system 300 described with reference to FIG. 3. As will be appreciated by the skilled reader, elements of system 400 that are similarly number to those described with reference to system 200 operate in the same way in both embodiments. Moreover, elements of system 400 that are similarly numbered to those described with reference to system 300 operate in the same way in both embodiments.

In some embodiments, three-way electronic valve 402 may be operable to divert fluid from a single input to both outputs (with each output receiving a configurable proportion of the input) under electronic control. Moreover, in some embodiments, fuel-operated heater 401 may be operable to produce a variable fluid output such that, when used in conjunction with the three-way electronic valve 402 as described above, each output of the three-way electronic valve 402 generates enough pressure to effectively operate the battery heating system components and the cabin heating system components.

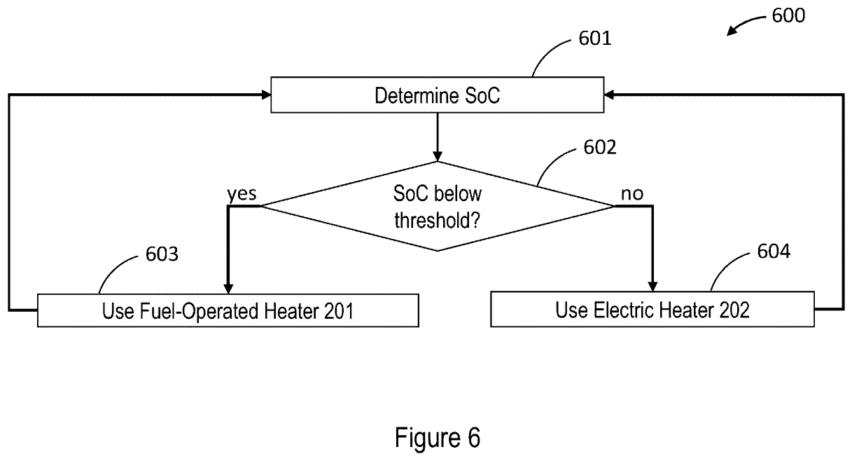

FIG. 5 is a schematic diagram showing a control system 500 for control the temperature management systems 200, 300, 400 described elsewhere herein in accordance with various methods 600, 700, 800, 900, 1000 also described elsewhere herein. The control system 500 may include a processor 503, memory 508 including one or more data storage devices 509. Processor 503 may comprise one or more processors for performing processing operations that implement functionality of the various methods described herein with reference to FIGS. 6 to 12, for example. Processor 503 may be a general-purpose processor executing program code stored in memory 508 to which is has access. Alternatively, a processor of the processors 503 may be a specific-purpose processor comprising one or more preprogrammed hardware or firmware elements (e.g., application-specific integrated circuits (ASICs), electrically erasable programmable read-only memories (EEPROMs), etc.) or other related elements.

Memory 508 comprises one or more storage devices 509 for storing program code executed by processor 503 and data used during operation of processor 503. Memory 508 may be a semiconductor medium (including, e.g., a solid-state memory), a magnetic storage medium, an optical storage medium, and/or any other suitable type of memory. A storage device 509 of memory 508 may be read-only memory (ROM) and/or random-access memory (RAM), for example.

In some embodiments, two or more elements of processor 503 may be implemented by devices that are physically distinct from one another and may be connected to one another via data-communication bus 507. As will be appreciated by the skilled reader, the hardware components of the control system 500 may be implemented in any suitable way in order to implement the methods disclosed herein.

In some embodiments, control system 500 can include one or more location information systems 501. Location information systems 501 are configured to determine the physical location of electric vehicle 100 over time, and may be implemented using any known technology, including, but not limited, to Global Positioning System (GPS), WiFi positioning systems (WPS), Near Field Communication (NFC), Radio-Frequency Identification (RFID), Bluetooth Low Energy (BLE) beacons, Quick Response (QR) codes. As will be appreciated by the skilled reader, any other suitable technology may be used. As will also be appreciated by the skilled reader, once the physical location of electric vehicle 100 is established over a period of time with sufficient granularity, it is possible to determine not only the route of electric vehicle 100, but also the speed and acceleration of electric vehicle 100, as well as the time electric vehicle 100 spends at particular locations, each of which can be determined by the systems and methods disclosed herein. The location information generated by and/or stored in the location information systems 501 can be used by the processor 503 in implemented the methods described herein.

In some embodiments, the location information can be used in conjunction with known methods of creating geofences. For example, geographic zones can be established and the control system 500 can use information from the location information systems 501 to determine whether the electric vehicle 100 is located within a geographic zone.

In some embodiments, control system 500 can include one or more environmental information systems 502. Environmental information systems 502 can include devices for measuring exterior temperature, relative humidity, and barometric pressure values. Environmental information systems 502 may also be operable to store predictions relating to environmental conditions (e.g., temperature) for certain periods of time during which the electric vehicle 100 may be in operation. Environmental information generated by and/or stored in environmental information systems 502 can be used by the processor 503 in implemented the methods described herein.

In some embodiments, the control system 500 can include one or more vehicle information systems 512. Vehicle information systems 512 can, for example, include devices for measuring the State of Charge (SoC) of the battery of the electric vehicle 100, the temperature in the cabin of the electric vehicle 100, and the temperature of battery cells in the battery of the electric vehicle 100. Vehicle information generated by and/or stored in vehicle information systems 512 can be used by the processor 503 in implemented the methods described herein.

In some embodiments, control system 500 can include a communication module 511 configured to communicate with other parts of the electric vehicle 100, such as communication device 505 and/or temperature management systems 200, 300, 400. In some embodiments, communication module 511 is configured to communicate via the vehicle communication and diagnostic systems 504. In some embodiments, the vehicle communication and diagnostic systems 504 is a standard vehicle bus, such as a vehicle bus in accordance with the Society of Automotive Engineers' standard SAE J1939, which is widely used by automotive manufacturers.

The control system 500 may also be configured to interface and be controlled by communication device 505 configured to implement User Interface (UI) 510 for allowing users to monitor the control system 500, as well as to interact with the control system 500 in accordance with some methods described herein. For example, in some embodiments, the communication device 505 may communicate user defined instructions to the control system 500 via the vehicle communication and diagnostic systems 504. In some embodiments, the communication device might be a wired control panel and the user interface can be a series of dials for controlling the actions of the temperature management systems 200, 300, 400. In other embodiments, the communication device 505 may be a smartphone, tablet, head-mounted display, or other communication device which is carried or worn by the user of the electric vehicle 100 and which itself may have established wired or wireless communication with the vehicle communication and diagnostic systems 504.

In some embodiments, the control system 500 may alternatively or additionally be powered by a backup battery or other alternate power supply. In some embodiments, such a backup battery could be a 12V automotive battery.

Now, with reference to FIGS. 6 to 12, various methods of operating temperature management systems 200, 300 and 400 will now be described. During normal operation, cabin temperature management system 300 will be controlled so that it is set by default to electric heating of the heat transfer fluid by electric heater 302 but will switch to fuel-operated heater 301 when predefined specific conditions are met or when the override is manually controlled by a user using the User Interface 510.

In some embodiments, both electric heater 302 and fuel-operated heater 301 may operate simultaneously. For example, when there is a relatively high cabin heating demand, the vehicle is in a relatively cold environment, and the SoC is relatively high, both electric heater 302 and fuel-operated heater 301 may operate simultaneously.

Moreover, during normal operation, battery temperature management system 200 will be controlled to keep the temperature of battery of the electric vehicle within an acceptable range for optimal performance and recharge at all times. In some embodiments, an acceptable temperature range for the battery cells of the electric vehicle may be between 5° C. and 25° C. for optimal performance and battery durability. In other modes of operation however, or when manually controlled by a user using the User Interface 510, optimal performance and recharge of the battery may be deprioritized, as described in more detail elsewhere herein.

FIG. 6 is a block diagram of an example method 600 for controlling the battery temperature management systems 200, 400 in accordance with a mode of operation carried out by the system of FIG. 5. At step 601, the state of charge (SoC) of the battery of electric vehicle 100 is determined. Then, at step 602, the control system 500 determines whether the SoC is below a certain threshold. In some embodiments, the SoC threshold can be 30%. If the SoC is below the threshold, then the control system 500 controls temperature management systems 200, 400 such that the heat transfer fluid is heated using fuel-operated heater 201 at step 603. If, on the other hand, the SoC is not below the threshold, then the control system 500 controls temperature management systems 200, 400 such that the heat transfer fluid is heated using electric heater 202 at step 604. After each of the above eventualities, the method is repeated at step 601. As will be appreciated by the skilled reader, when the SoC is low, use of the fuel-operated heater 201 allows remaining battery energy to be directed to the drive train of the electric vehicle 100, thereby increasing the range of the electric vehicle 100.

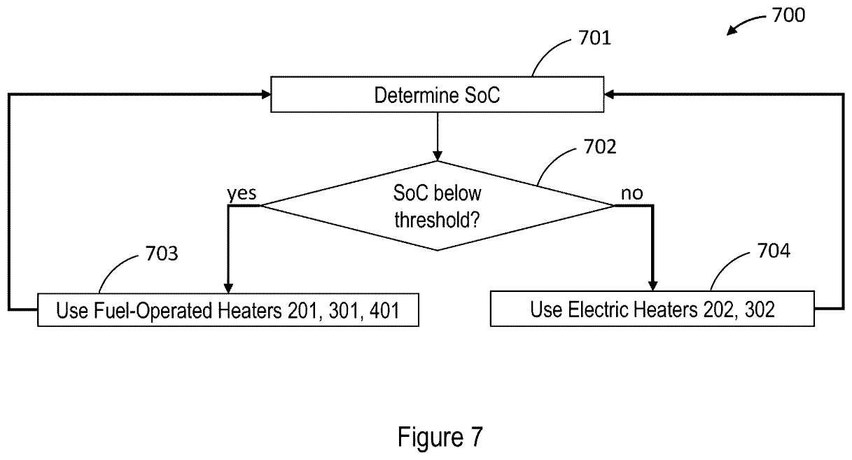

FIG. 7 is a block diagram of an example method 700 for controlling the battery temperature management systems 200, 400 and cabin temperature management systems 300, 400 in accordance with a mode of operation carried out by the system of FIG. 5. At step 701, the state of charge (SoC) of the battery of electric vehicle 100 is determined. Then, at step 702, the control system 500 determines whether the SoC is below a certain threshold. In some embodiments, the SoC threshold is 30%. If the SoC is below the threshold, then the control system 500 controls battery temperature management systems 200, 400 and cabin temperature management systems 300, 400 such that the heat transfer fluid is heated using fuel-operated heater 201, 301, 401 at step 703. If, on the other hand, the SoC is not below the threshold, then the control system 500 controls battery temperature management systems 200, 400 and cabin temperature management systems 300, 400 such that the heat transfer fluid is heated using electric heaters 202, 302 at step 604. After each of the above eventualities, the method is repeated at step 701.

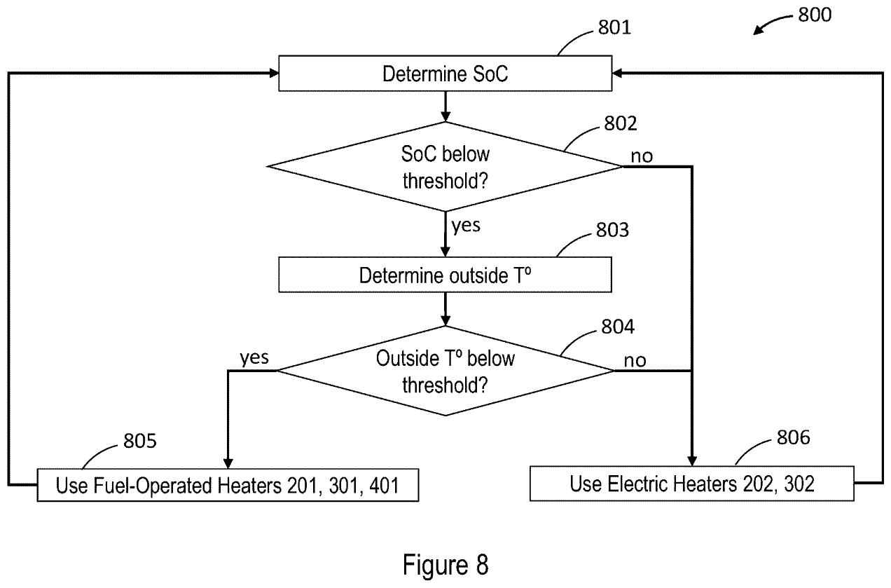

FIG. 8 is a block diagram of an example method 800 for controlling the battery temperature management systems 200, 400 and cabin temperature management systems 300, 400 in accordance with a mode of operation carried out by the system of FIG. 5. At step 801, the state of charge (SoC) of the battery of electric vehicle 100 is determined. Then, at step 802, the control system 500 determines whether the SoC is below a certain threshold. If the SoC is not below the threshold, then the control system 500 controls battery temperature management systems 200, 400 and cabin temperature management systems 300, 400 such that the heat transfer fluid is heated using electric heaters 202, 302 at step 806. If, on the other hand, the SoC is below the threshold, then the control system 500 determines the ambient temperature outside of electric vehicle 100 at step 803. As will be appreciated by the skilled reader, this can be done using environment information systems 502 described elsewhere herein.

Then, at step 804, the control system 500 determines whether the outside temperature is below a certain threshold. In some embodiments, the threshold may be −10° C. Below this threshold, becomes critical to preserve operator and passenger safety by limiting the draw on electric heaters until the electric vehicle 100 is returned to a charging point and/or temperature-regulated shelter. If the outside temperature is not below the threshold, then the control system 500 controls battery temperature management systems 200, 400 and cabin temperature management systems 300, 400 such that the heat transfer fluid is heated using electric heaters 202, 302 at step 806. If, on the other hand, the outside temperature is below the threshold, then the control system 500 controls battery temperature management systems 200, 400 and cabin temperature management systems 300, 400 such that the heat transfer fluid is heated using fuel-operated heater 201, 301, 401 at step 805. After each of the above eventualities, the method is repeated at step 801.

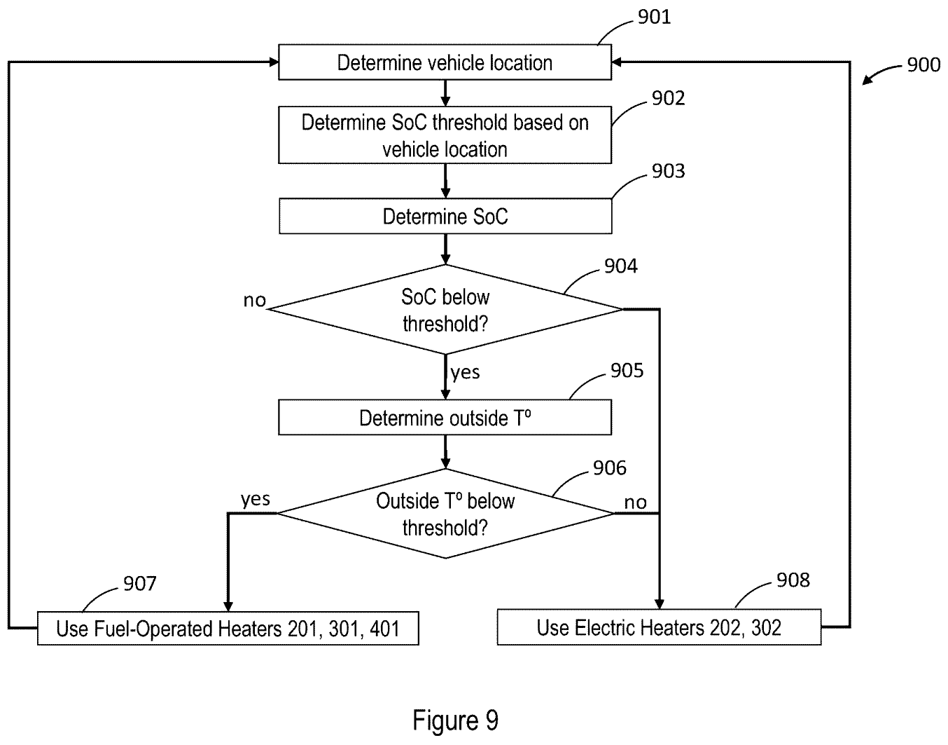

FIG. 9 is a block diagram of an example method 900 for controlling the battery temperature management systems 200, 400 and cabin temperature management systems 300, 400 in accordance with a mode of operation carried out by the system of FIG. 5. First, at step 901, the control system 500 determines the geographic location of electric vehicle 100 at step 901. As will be appreciated by the skilled reader, this can be done using location information systems 501 described elsewhere herein. Then, at step 902, the control system 500 can determine the threshold SoC based on the geographic location of the electric vehicle 100. For example, the SoC threshold may be based on the distance of the geographic location of electric vehicle 100 from a charging station (i.e., the amount of charge required for the electric vehicle 100 to travel from its present geographic location to the near, or a given, charging station). In another example, the SoC threshold may be based on the distance of the geographic location of electric vehicle 100 from a location at which a user of the vehicle may find heated shelter (i.e., the amount of charge required for the electric vehicle 100 to travel from its present geographic location to the nearest heated shelter).

In some embodiments, the SoC threshold may be determined based on the presence of the electric vehicle in one or more geofenced zones. In one example, the size, shape and/or location of the geofenced zones can be altered based on the outdoor temperature and/or other weather conditions (e.g., the presence of blizzards). As such, it may be possible to vary the SoC threshold based on the location of the vehicle and the outdoor temperature and/or other weather conditions.

At step 903, the state of charge (SoC) of the battery of electric vehicle 100 is determined. Then, at step 904, the control system 500 determines whether the SoC is below the threshold determined at step 902. If the SoC is not below the threshold, then the control system 500 controls battery temperature management systems 200, 400 and cabin temperature management systems 300, 400 such that the heat transfer fluid is heated using electric heaters 202, 302, at step 908. If, on the other hand, the SoC is below the threshold, then the control system 500 determines the ambient temperature outside of electric vehicle 100 at step 905. As will be appreciated by the skilled reader, this can be done using environment information systems 502 described elsewhere herein. Then, at step 906, the control system 500 determines whether the outside temperature is below a certain threshold.

If the outside temperature is not below the threshold, then the control system 500 controls battery temperature management systems 200, 400 and cabin temperature management systems 300, 400 such that the heat transfer fluid is heated using electric heaters 202, 302 at step 908. If, on the other hand, the outside temperature is below the threshold, then the control system 500 controls battery temperature management systems 200, 400 and cabin temperature management systems 300, 400 such that the heat transfer fluid is heated using fuel-operated heater 201, 301, 401 at step 907. After each of the above eventualities, the method is repeated at step 901.

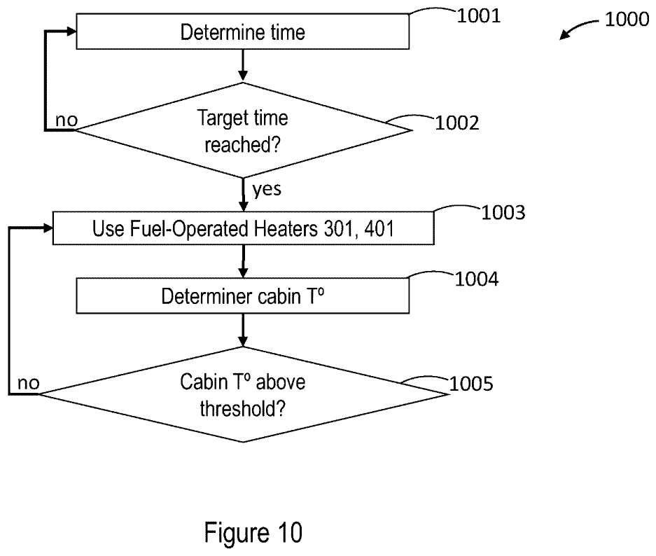

FIG. 10 is a block diagram of an example method 1000 for controlling the cabin temperature management systems 300, 400 in accordance with a mode of operation carried out by the system of FIG. 5. The method 1000 shown in FIG. 10 can be used when the electric vehicle is turned off in a cold and remote location for a long period of time and requires pre-heating of the cabin at a specific time for subsequent use of electric vehicle 100. For example, electric vehicle 100 may be parked in a cold and remote location for several days, but an operator may know that the vehicle will be required on a specific day and at a specific time. In such circumstances, the method 1000 of FIG. 10 may be used to pre-heat the cabin at a specific target time.

At step 1001, the control system 500 determines the current time before determining whether the current time has reached a target time at step 1002. For example, the target time could be 05:00 on a particular day of a particular month in a particular year. As shown in steps 1001 and 1002, the control system 500 monitors the current time until the current time matches the target time. When the target time is achieved, the control system 500 controls cabin temperature management systems 300, 400 such that the heat transfer fluid is heated using fuel-operated heater 301, 401 at step 1003. By doing so, cabin temperature management systems 300, 400 begin to heat the cabin of the electric vehicle.

At step 1004, the control system 500 determines the temperature of the cabin of the electric vehicle. Then, at step 1005, the control system 500 determines whether the temperature of the cabin of the electric vehicle 100 is above a threshold temperature allowing the electric vehicle to be comfortably used by a human operator. In some embodiments, this threshold can be 5° C. If the temperature of the cabin of the electric vehicle 100 is above the threshold, the control system 500 stops using the fuel-operated heaters 301, 401 to heat the cabin. Once method 1000 is complete, the control system 500 can return to a normal operating mode, or any other operating mode.

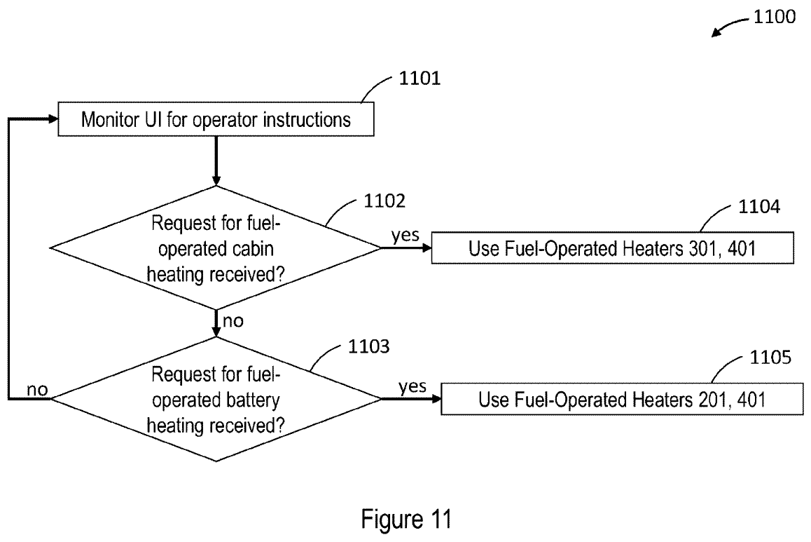

FIG. 11 is a block diagram of an example method 1100 for controlling the battery temperature management systems 200, 400 and cabin temperature management systems 300, 400 in accordance with a mode of operation carried out by the system of FIG. 5. The method 1100 can be combined with, or form part of, any of the other methods described herein. For example, in some embodiments, method 1100 can form part of methods 600, 700, 800, 900, and/or 1000.

At step 1101, control system 500 monitors for inputs received from the user by way of the user interface 510 of the communication device 505. If, at step 1102, a determination is made that the user has made a manual request for fuel-operated cabin heating, the control system 500 controls cabin temperature management systems 300, 400 such that the heat transfer fluid is heated using fuel-operated heater 301, 401 at step 1104. Similarly, if, at step 1103, a determination is made that the user has made a manual request for fuel-operated battery heating, the control system 500 controls battery temperature management systems 200, 400 such that the heat transfer fluid is heated using fuel-operated heater 301, 401 at step 1105. As will be appreciated by the skilled reader, by implementing method 1100, control system 500 can provide a manual override feature to any of the operating modes described herein. As will be appreciated by the skilled reader, in some embodiments, steps 1102 and 1103 can be combined into a single step. In such embodiments, a single request made by the operator of electric vehicle 100 can be used to control system 500, which controls battery temperature management systems 200, 300, 400 such that the heat transfer fluid is heated using fuel-operated heater 201, 301, 401 at steps 1104 and 1105.

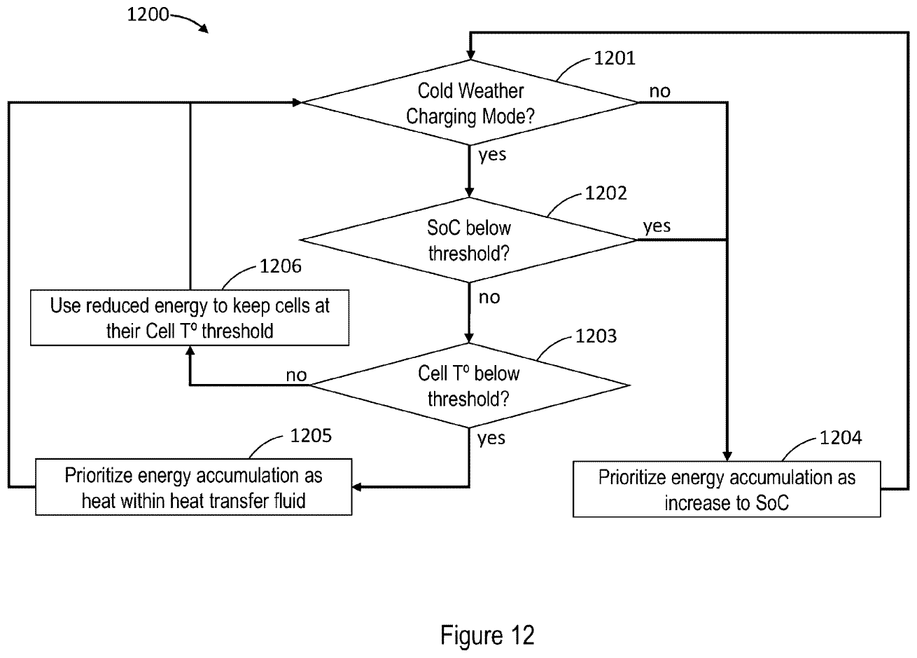

FIG. 12 is a block diagram of a method 1200 for charging a vehicle comprising battery temperature management systems 200, 400 and cabin temperature management systems 300, 400 in accordance with the present disclosure. As will be appreciated by the skilled reader, electricity can be supplied to the vehicle in any suitable known way, using any suitable know charging equipment and associated outside energy source. As electricity is supplied to the vehicle, it can be used in accordance with the method of FIG. 12. The aim of the method of FIG. 12 is to use as close to 100% of the energy received from the outside energy source towards increasing the SoC of the battery, except in situations in which the battery may be too cold (e.g., below its optimal temperature range). In such situations, a relatively small amount of the energy received from the outside energy source is used to heat the battery in order to increase its lifespan.

At step 1201, a determination is made as to whether a cold weather charging mode of electric vehicle 100 is activated. In some embodiments, an operator can activate the cold weather charging mode manually using the user interface 510. In other embodiments, the cold weather charging mode can be activated automatically by the control system 500, based on outdoor temperature values received from environmental information systems 502. If the cold weather mode is not activated, the energy received from the outside energy source is mainly used to increase the SoC of the battery of the electric vehicle 100 at step 1204.

If the cold weather mode is activated, a determination is made at step 1202 as to whether the SoC is below a threshold. In some embodiments, the threshold may be 80%. As will be appreciated by the skilled reader, it may be desirable to avoid charging a battery beyond a SoC threshold in order to manage battery performance and increase battery lifespan. If the SoC is below the threshold, the energy received from the outside energy source is mainly used to increase the SoC of the battery of the electric vehicle 100 at step 1204. In one non-limiting example, 100% of the energy received from the outside energy source could be used to increase the SoC of the battery of the electric vehicle.

If, on the other hand, the SoC is above the threshold, a determination is made as to whether the cell temperature of the battery of electric vehicle 100 is below a certain threshold at step 1203.

If the cell temperature is above the threshold, a reduced amount of energy from the outside energy source is used to maintain the cell temperature at or around the threshold at step 1206. As will be appreciated by the skilled reader, if the battery is charged and the cell temperature is above the threshold, then the amount of energy being drawn from the outside energy source will be significantly reduced. In a non-limiting example, 50% of the reduced amount of energy received from the outside energy source could be used to maintain the cell temperature at or around the threshold at step 1206, while 50% of the reduced amount of energy received from the outside energy source could be used to conserve the

SoC of the battery. In this mode, the relatively small amount of energy received from the outside energy source to conserve the SoC of the battery can be used to power various pumps and auxiliary systems in order to avoid drawing energy from the battery. In some embodiments, the cell temperature threshold can be value found within the optimal cell temperature range, as described in more detail elsewhere herein.

If, on the other hand, the cell temperature is below the threshold, then the energy received from the outside energy source is mainly used to increase the temperature of the heat transfer fluid using electric heater 202 in battery temperature management system 200, 400 at step 1205, which allows to effectively store energy as heat in the battery thermal management system 200, 400. In a non-limiting example, 98% of the energy received from the outside energy source could be used to maintain the cell temperature at or around the threshold, while 2% of the energy received from the outside energy source could be used to conserve the SoC of the battery. In this mode, the relatively small amount of energy received from the outside energy source to conserve the SoC of the battery can be used to power various pumps and auxiliary systems in order to avoid drawing energy from the battery.

As shown on FIG. 12, this prioritization of the heat transfer fluid is maintained until the cell temperature has been raised to a temperature above the threshold at step 1203.

A person of skill in the art will readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The description and drawings merely illustrate the principles of the invention. It will thus be appreciated that those skilled in the art will be able to devise various arrangements that, although not explicitly described or shown herein, embody the principles of the invention and are included within the scope of the appended claims. Furthermore, all examples recited herein are principally intended expressly to be only for pedagogical purposes to aid the reader in understanding the principles of the invention and the concepts contributed by the inventors to furthering the art and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the Figures, including any functional blocks labelled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

1. A system for managing the temperature of a battery in an electric vehicle, the system comprising:
a fuel-operated heater configured to heat a heat transfer fluid;
an electric heater configured to heat the heat transfer fluid;
a control system configured to selectively operate the fuel-operated heater or the electric heater; and
a thermally insulated battery enclosure configured to receive heated heat transfer fluid to heat the battery.

2. The system of claim 1, wherein the fuel-operated heater is a diesel heater.

3. The system of claim 2, wherein the fuel-operated heater is one of a parking heater, a diesel-fired air heater, a diesel-fired coolant heater, a petrol-fired air heater and a petrol-fired coolant heater.

4. The system of claim 1, further comprising a heat exchanger configured to heat a cabin of the electric vehicle using the heat transfer fluid.

5. The system of claim 4, further comprising a second fuel-operated heater configured to heat the heat transfer fluid used by the heat exchanger.

6. The system of claim 5, further comprising a second electric heater configured to heat the heat transfer fluid used by the heat exchanger.

7. The system of claim 1, wherein the control system is operable by an operator of the electric vehicle.

8. The system of claim 1, wherein the control system is configured to automatically select operation of the electric heater or the fuel-operated heater based at least in part on the state of charge of the battery of the electric vehicle.

9. The system of claim 1, wherein the control system is configured to automatically select operation of the electric heater or the fuel-operated heater based at least in part on the location of the electric vehicle.

10. The system of claim 1, wherein the control system is configured to automatically select operation of the electric heater or the fuel-operated heater based at least in part on the temperature outside the electric vehicle.

11. The system of claim 1, wherein the control system is configured to automatically select operation of the electric heater or the fuel-operated heater based at least in part on the temperature of the battery of the electric vehicle.

12. A method of operating the system of claim 1 comprising:
determining the state of charge (SoC) of the battery of the electric vehicle; and
selecting the fuel-operated heater if the state of charge (SoC) is below a threshold.

13. A method of operating the system of claim 1 comprising:
determining the state of charge (SoC) of the battery of the electric vehicle;
determining the temperature outside the electric vehicle; and
selecting the fuel-operated heater if the state of charge (SoC) is below a state of charge threshold and the temperature outside the electric vehicle is below an outside temperature threshold.

14. A method of operating the system of claim 1 comprising:
determining the geographic location of the electric vehicle;
determining a state of charge threshold based at least in part on the geographic location of the electric vehicle;
determining the state of charge (SoC) of the battery of the electric vehicle;
determining the temperature outside the electric vehicle; and
selecting the fuel-operated heater if the state of charge (SoC) is below the determined state of charge threshold and the temperature outside the electric vehicle is below an outside temperature threshold.

15. A method of operating the system of claim 6 comprising heating the cabin to a predetermined temperature at a predetermined time using the second fuel-operated heater.

16. The methods of claim 12, further comprising:
receiving instructions from the operator of the electric vehicle; and
selectively operating the fuel-operated heater or the electric heater based on a request contained in the instructions.

17. A method of charging an electric vehicle comprising the system of claim 1, comprising:
determining the state of charge (SoC) of the battery of the electric vehicle;
determining the temperature of the battery of the electric vehicle;
prioritizing the use of the received charging energy to heat the heat transfer fluid using the electric heater if the state of charge (SoC) is above a state of charge threshold and the temperature of the battery of the electric vehicle is below a battery temperature threshold; and
prioritizing the use of the received charging energy to increase state of charge (SoC) of the battery of the electric vehicle if the state of charge (SoC) is not above a state of charge threshold or the temperature of the battery of the electric vehicle is not below a battery temperature threshold.

18. The method of claim 17, wherein prioritizing the use of the received charging energy to heat the heat transfer fluid using the electric heater comprises using 98% of the energy received from the outside energy source to maintain the temperature of the battery above the battery temperature threshold and using 2% of the energy received from the outside energy source to conserve the SoC of the battery.

19. The method of claim 17, wherein prioritizing the use of the received charging energy to increase the state of charge (SoC) of the battery of the electric vehicle comprises using 100% of the energy received from the outside energy source to increase the state of charge of the battery of the electric vehicle

20. A method of charging an electric vehicle comprising the system of claim 3, comprising:
determining the state of charge (SoC) of the battery of the electric vehicle;
determining the temperature of the battery of the electric vehicle;
prioritizing the use of the received charging energy to heat the heat transfer fluid using the electric heater if the state of charge (SoC) is above a state of charge threshold and the temperature of the battery of the electric vehicle is below a battery temperature threshold; and
prioritizing the use of the received charging energy to increase state of charge (SoC) of the battery of the electric vehicle if the state of charge (SoC) is not above a state of charge threshold or the temperature of the battery of the electric vehicle is not below a battery temperature threshold.
